(19) United States
(12) Patent Application Publication
(10) Pub. No.: US 2008/0253106 A1
(43) Pub. Date: Oct. 16, 2008

(54) Uv Activated Electronic Window

(75) Inventors: Adrianus Sempel, Eindhoven (NL); Cornelia Titia Staats, Eindhoven (NL); Joseph Franciscus Raymond Eijsermans, Eindhoven (NL); Piet Antonis, Eindhoven (NL); Onno Van Tertholen, Eindhoven (NL); Gerrit Jan Teije Huijgen, Eindhoven (NL); Lars Rene Christian Waumans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,241

(22) PCT Filed: Sep. 29, 2006
(86) PCT No.: PCT/IB06/53565

§ 371 Date: Apr. 4, 2008

(30) Foreign Application Priority Data
Oct. 7, 2005 (EP) 05109349.0

(51) Int. Cl. F21V 9/16

(52) U.S. Cl. 362/84

(57) ABSTRACT

An area light source (1) comprising a first light source (2) emitting light (L2) in a first wavelength range, and a light-transparent carrier screen (4) coated with a phosphorous layer (5) is disclosed. The area light source is characterised in that it comprises at least one additional light source (3) projecting light L3 in a second wavelength range, differing from said first wavelength range onto the carrier screen (4), said projected light L3 being capable of exciting the phosphorous layer (5).

The present invention relates to an area light source comprising a first light source emitting light in a first wavelength range, and a light-transparent carrier screen coated with a phosphorous layer.

Light projection is known from many applications. Also the use of UV light combined with phosphor for conversion into visible light is well known and widely used in fluorescent tubes. These also are present in the form of large area flat light sources known in art. In JP-A-08 045 321 plural gas discharge lamps radiating in the same ultraviolet wavelength range are arranged to shine onto a light transmission sheet coated with a fluorescent agent which is consequently excited by UV radiation and emitting visible light through the sheet as it fluoresces.

Here measures are taken to obtain an evenness in visual sense resulting in a uniform illumination. The use of a large screen area radiated by a plurality of light sources eliminates shadowing effects and avoids visual unevenness. To avoid shadowing effects, the fluorescent agent coat must be applied uniformly over the entire screen.

This construction however does not permit local illumination of the screen. The lighting system contains a plurality of invisible-light sources. The construction is limited to light sources which only produce radiation other than in a visible wavelength. Moreover, a pixellation of the visible light generated cannot be performed. Also a multicolour lamp cannot be constructed in this way. This solution limits the abilities of the lighting system.

The mechanical construction is limited to a rectangular parallelepiped box with the fluorescent agent coat layer formed on the inner side, which limits freedom in manufacturing and usage of such a lamp.

The invention aims at overcoming previously existing drawbacks concerning large area flat light sources and further increase the flexibility by providing an area light source comprising a first light source emitting light in a first wavelength range, and a light transparent carrier screen coated with a phosphorous layer, further comprising at least one additional light source projecting light in a second wavelength range, differing from said first wavelength range, onto the carrier screen, said projected light being capable of exciting the phosphorous layer. The phosphor will preferably emit light in the visible wavelength range.

The phosphorous coating can be arranged on either side of the carrier screen, depending on the conditions of a specific case in order to give proper advantages, as long as it can be excited by the additional light source.

The use of an additional light source capable of exciting a phosphorous layer, combined with a first light source introduces additional degrees of freedom in the range of variation, regarding colour, intensity, spatial variations etc.

According to one aspect of the invention the carrier screen, and thus the phosphorous coating, is arranged between an object to be illuminated and the additional light source. This is advantageous since the carrier screen then also can be used as a filter, or carrier for a filter, e.g. having properties to filter the UV component from the additional light source and thus preventing unsuitable radiation from reaching said object, e.g. a viewer. The carrier screen could also be arranged to permit passage of such an amount of ultraviolet light so as to effectively work as a tanning device or a suitable substitute for sunlight in another context.

The opposite, that the additional light source is arranged between the carrier screen and the object to be illuminated is an alternative. This is especially beneficial if the carrier screen constitutes a part of the first light source, which e.g. could be an illumination box in which case the application of a coating on a side of a diffuser of the illumination box is a convenient solution.

An additional carrier or filtering element could be arranged between the viewer and the additional light source in this case, e.g. in order to protect the viewer from harmful radiation in accordance with the above description.

The additional source of light can comprise several, independently controllable light sources. This further increases the dynamics and possibilities of variations in the inventive device. A spatial distribution of the light sources can give a dynamic spatially distributed effect.

According to one aspect of the invention at least one of the independently controllable light sources emits light with a different wavelength spectrum than the others, which further increases the dynamics. In combination with the feature that the phosphorus coating comprises several layers and/or structures of the same, or different phosphorus materials, this results in various effects being possible. This also makes it possible to selectively activate various parts of the phosphorous material on the carrier screen in order for it to display various patterns, both structural and spectral. That is, spatial variations can be obtained by proper patterning of the phosphorous layer or by local excitation/activation of the phosphorous layer or combinations of these. Finally, various UV light sources can be used with different wavelength or power, which enhances the effect of geometrical and spectral variation of the visible output light.

The additional source of light can also comprise an image projection device, e.g., based on DMD technology or based on the methods as used for IC-patterning such as a controllable UV light source or scanning UV spot such as a “UV pointer”, rendering the possibilities to display information such as text or detailed images on the carrier screen. The device would then constitute a UV optically addressed display. The additional source of light could also comprise a scanning UV-laser. For simplicity these kind of devices is here called UV-beamer.

In the inventive device, a suitable material for the carrier screen could be glass, if the UV light should be suppressed, quartz glass if not. It could also consist of a bendable or flexible plastic sheet, a woven textile structure or whatever material is considered suitable for a specific situation.

The additional light source can comprise LEDs, gas discharge devices, etc.

A combination of an electrical addressed phosphor layer (like the Electro Luminescence from Durell) with UV activation is also possible. A well-known construction consists of a layer stack applied on a substrate like a glass substrate or a flexible foil substrate: in one embodiment, a phosphor layer and a dielectric layer are sandwiched between conductive layers. A voltage applied to the conductive layers forces an electrical field within the phosphor layer that accelerates electrons. These electrons activate the phosphor particles and visible light is radiated. As the capacitance formed by the dielectric layer is charged by the electrons, the electrical field across the phosphorous layer is reduced and light emission stops, while the electrical field across the dielectric layer increases. In case of AC drive, the external voltage is reversed which accelerates the stored electrons back into the phosphor layer while activating again the phosphor particles. In this way a light flash is generated at every reversing of the AC voltage. For sufficiently high frequency of the AC voltage, no individual flashes are observed by the human eye. Apart from this electrical activation of the phosphorous layer, a separately controllable UV source can be used for optical activation. The higher energy UV light activates the phosphor that absorbs the energy while radiating visible light. Here the phosphorous layer is activated by both electrical power and optical power, being two independent energy sources. As a result across a larger area, for instance a uniform light emission is caused by the electrical activation, while additional optical activation by UV locally causes extra visible light. In this way intensity variations of the visible light across the screen area can be obtained.

The inventive device will in the following be described referring to specific embodiments given as examples only and referring to the drawings.

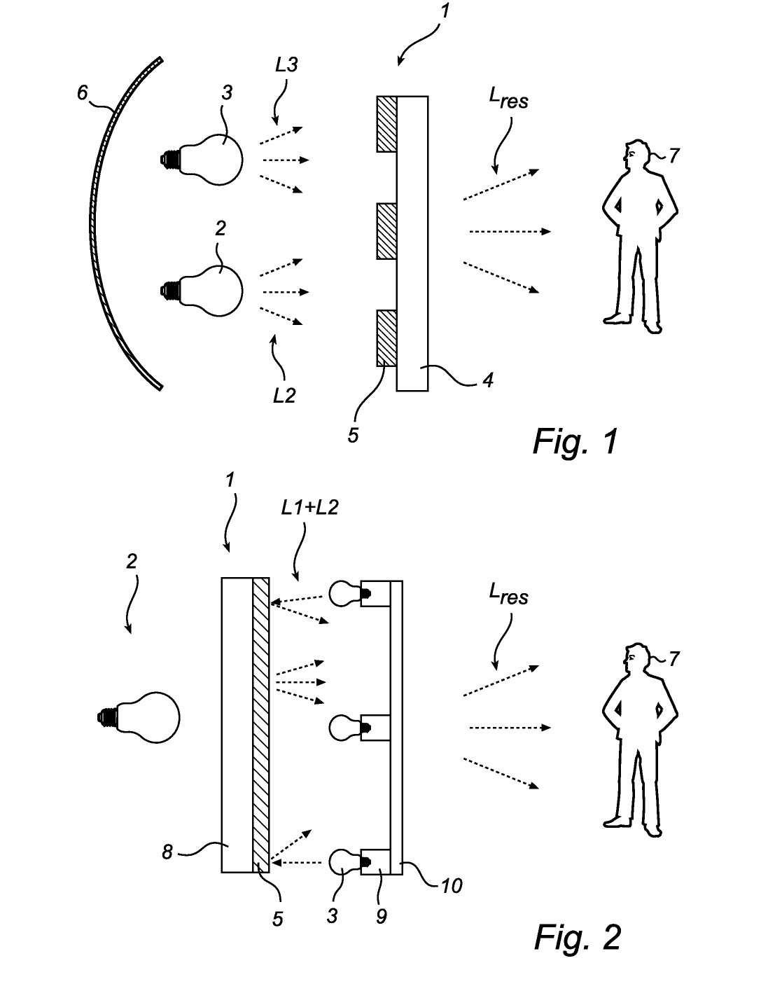

FIG. 1 is a schematic of the inventive device according to a first embodiment.

FIG. 2 is a schematic the inventive device according to a second embodiment.

In FIG. 1 the basic idea of an inventive device is displayed. This device is a flat large area light source 1 having a visible-light source 2 and a UV source 3, schematically depicted as light bulbs. The light L2 and L3, generally indicated by the straight arrows, from the light sources 2 and 3 respectively, is directed towards a transparent carrier screen 4 made of glass or any other transparent material and carrying a phosphor layer 5, which may be patterned. A reflector 6 aids in directing back-scattered radiation. The light from the visible-light source will pass through the phosphor layer 5 and the screen 4, while the UV light will be converted by the phosphor 5 into visible light before it passes the screen 4. Any residual UV light will be efficiently suppressed by the glass screen 4. A viewer 7 will experience the spectrum from the visible-light source combined with the converted UV light, Lres, and the wavelength and spatial intensity distribution of the converted UV light will, among other things, be governed by the patterned phosphor layer 5 and by the area which is radiated by the light sources L2, L3.

The phosphorous layer can be applied by various techniques, e.g., by dip-coating, flow-coating, embossing, screen-printing to allow unpatterned or patterned layer structures. Selective etching and locally mechanical removal of the layer are alternatives for patterning. Also techniques as used in the manufacturing of CRT display screens can be used.

An alternative way of creating a pattern is to locally block the UV light from reaching the phosphorous layer 5. This can be accomplished by adding a shaped glass plate between the light source 3 and/or 2 and the phosphorous layer 5. This shaped glass plate locally prevents UV light to hit the phosphorous layer, which causes a (fixed) light pattern.

In another large area flat light source according to the first embodiment the visible-light source 2 emits blue light L2 and the phosphor 4 converts the UV light L3 into yellow radiation. In this case the viewer will experience a light pattern resembling a blue sky with clouds.

FIG. 2 shows an embodiment of a flat large area light box (1) consisting of a visible light source 2. This light box may comprise a diffuser 8 to soften the light emitted by a light source. In this second embodiment a phosphorous layer 5 is applied on top of the diffuser 8. Also an extra transparent carrier screen can be added on which the phosphorous layer is applied, not shown in the figure. An external frame 9 supporting the viewers' side window glass 10 also contains back-directed UV sources like LED's 3 that can be driven independently. When such an LED 3 is activated, its UV light is converted into visible light by the phosphorous layer 5. As a result the viewer observes mixed visible light Lres. In the construction shown, the window glass 10 protects the viewer 7 from residual UV light. The phosphorous layer may be covered by a protecting layer to enhance mechanical and chemical robustness.

Although the examples given focus on flat large area light sources, the inventive concept can also be applied to small sized lamps, not necessarily flat. Further, it must be emphasized that the first light source does not have to emit light in the visible region, but can equally well operate in the UV region. Further, as described, several different phosphors can be used. Phosphors are widely used for lighting applications like in fluorescent tubes and within LEDs to generate visible light or to optimise the visible light colour for a specific application. Also displays like CRT used for TV and monitor application contain phosphor to generate visible light; individual activation of the Red, Green, Blue phosphor sub-pixels by an electron beam allows light patterns to be generated in a large colour range.

Well-known fluorescent materials are YOX, BAM, BAM-green, LAP, YAG, CBT, MGM and others. It is clear that for a person skilled in the art, many phosphorous materials or combinations can be used for the present invention.

1. An area light source (1) comprising a first light source (2) emitting light (L2) in a first wavelength range, and a light-transparent carrier screen (4) coated with a phosphorous layer (5), characterized in that it further comprises at least one additional light source (3) projecting light L3 in a second wavelength range, differing from said first wavelength range onto the carrier screen (4), said projected light L3 being capable of exciting the phosphorous layer (5).

2. The area light source according to claim 1, wherein the phosphorous layer (5) is arranged on a side of the carrier screen (4) facing the object (7) to be illuminated.

3. The area light source according to claim 1, wherein the phosphorous layer (5) is arranged on the side of the carrier screens (4) facing the first light source (2).

4. The area light source according to 1, wherein the carrier screen (4) is arranged between said additional source of light (3) and said object (7).

5. The area light source according to claim 2, wherein the additional source of light (3) is arranged between the carrier screen (4) and the object (7).

6. The area light source according to claim a, wherein the additional source of light (3) comprises several, independently controllable light sources.

7. The area light source according to claim 6, wherein at least one of the independently controllable light sources emits light in a different wavelength range than the others.

8. The area light source according to claim 1, wherein the phosphorus coating (5) comprises several layers and/or structures of the same, or different, phosphorus materials.

9. The area light source according to claim 1, wherein the first source of light (2) emits radiation in the visible wavelength region and the additional source (3) of light emits radiation in a wavelength region such that it is transformable into visible light by the phosphorous coating (5).

10. The area light source according to claim 1, wherein the additional source of light (3) comprises a controllable UV beamer, a scanning UV spot or a scanning UV-laser.

11. The area light source according to claim 1, wherein the material for the carrier screen (4) comprises glass, quartz, plastic or a woven textile structure or any combination thereof.

12. The area light source according to claim 1, wherein the additional light source (3) consists of a number of light sources with identical or different invisible wavelengths for activating different geometrical areas or for activating different phosphor layers, thus allowing different visible patterns/colours to be shown.

13. The area light source according to claim 1, wherein the carrier screen (4) for the phosphorous layer (5) comprises a diffuser.
